(19) United States
(12) Patent Application Publication
(10) Pub. No.: US 2017/0320096 A1
(43) Pub. Date: Nov. 9, 2017

(54) APPARATUS, SYSTEM AND METHOD FOR INSTALLING A SCREEN ASSEMBLY IN A GYRATORY SIFTER

(71) Applicant: M-I LLC, Houston, TX (US)

(72) Inventor: Michael A. Timmerman, Cincinnati, OH (US)

(73) Assignee: M-I LLC, Houston, TX (US)

(21) Appl. No.: 15/145,632

(22) Filed: May 3, 2016

(51) Int. Cl. B07B 1/48; B07B 1/46; B07B 1/28

(52) U.S. Cl. CPC B07B 1/48; B07B 1/28; B07B 1/4672

(57) ABSTRACT

An apparatus, system and method provides for the installation of a filtration screen assembly in a vibratory separator. The apparatus has a screen rail extending across a vibratory separator. A ball box is inserted in the screen rail and encloses vibratory elements. A screen assembly is placed on the ball box parallel to the screen rail and extends across the vibratory separator. An inflatable seal is inserted into the screen rail and receives fluid to inflate and compress the screen assembly against the screen rail. A clamping element is attached to the screen assembly. The inflatable seal compresses the clamping element against the screen rail.

### BACKGROUND OF THE INVENTION

Sifters and vibratory separators are used in a variety of applications for separating materials by size. For example, sifters and vibratory separators may be used to separate sized particles or to separate solids from liquids. These devices may be used to screen materials in various industries for industrial sorting, manufacturing operations, oil and gas drilling and production operations, etc.

Gyratory sifters are used in a variety of applications for separating solids by size. These applications include separating particles of sugar, flour, sand and various chemical powders. Further, gyratory sifters may be used for both wet and dry screening and include aligned decks of screens or perforated plates, sloping from the head end and/or a feed end to the tail end and/or discharge end of the sifter. The screens may be disposed in a screen basket. The screen basket may be suspended by a set of hangers that allow the basket to move on a horizontal plane.

An eccentric drive mechanism, e.g., a belt driven eccentric weight, or other motive force may be coupled to the screen basket to provide a circular motion substantially across a horizontal plane of the gyratory sifter. Also, various dimensions and/or specifications of the gyratory sifter may be adjusted to accomplish specific separation and/or sifting goals. Devices described herein may be utilized to reduce the size of a screen used with a gyratory sifter prior to rolling of the screen for shipment and/or storage.

### DESCRIPTION OF THE DRAWINGS

FIG. 1 illustrates a perspective view of a screen rail of a vibratory separator with an inflatable seal in accordance with an embodiment of the invention.

FIG. 2 illustrates a side view of a screen rail in accordance with an embodiment of the invention.

FIG. 3 illustrates a side view of a flexible clamping element in accordance with an embodiment of the invention.

FIG. 4 illustrates a side view of a rolled screen assembly in accordance with an embodiment of the invention.

FIG. 5 illustrates a side view of a vibratory separator configured to receive a screen assembly in accordance with an embodiment of the invention.

### DETAILED DESCRIPTION

Embodiments disclosed herein are applicable to separation devices that may be utilized in numerous industries. While specific embodiments may be described as utilized in the oilfield services and related industries, such as use with gyratory sifters, the device may be applicable in other industries where separation of liquid-solid, solid-solid and other mixtures may be separated. The embodiments may be utilized in the mining, pharmaceutical, food, medical or other industries to separate such mixtures.

In the following detailed description, reference is made to accompanying figures, which form a part hereof. In the figures, similar symbols or identifiers typically identify similar components, unless context dictates otherwise. The illustrative embodiments described herein are not meant to be limiting. Other embodiments may be utilized, and other changes may be made, without departing from the spirit or scope of the subject matter presented here. It will be understood that the aspects of the present disclosure, as generally described herein, and illustrated in the figures, may be arranged, substituted, combined and designed in a wide variety of different configurations, which are explicitly contemplated and form part of this disclosure.

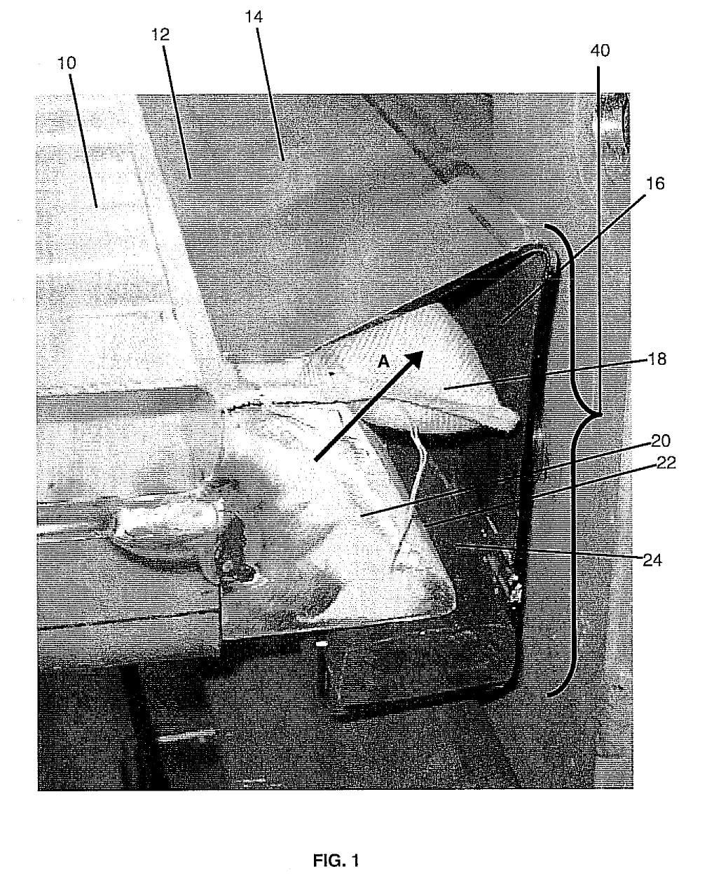

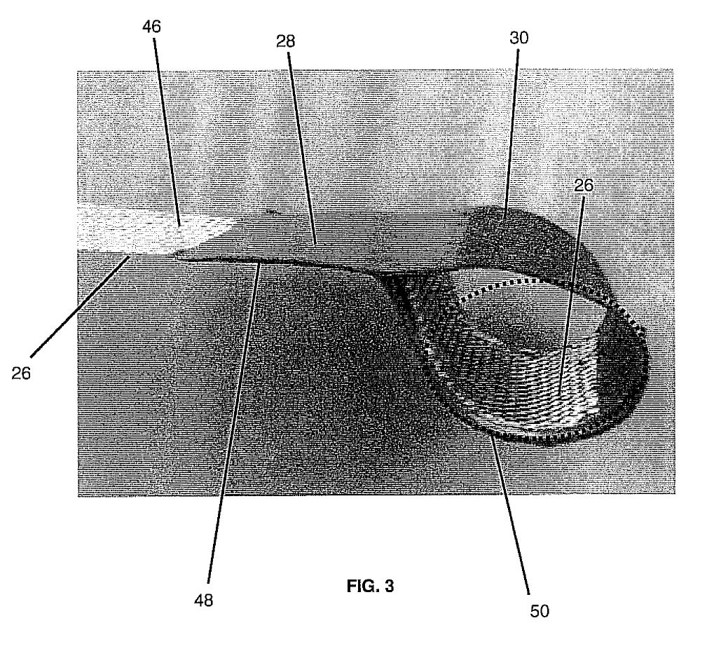

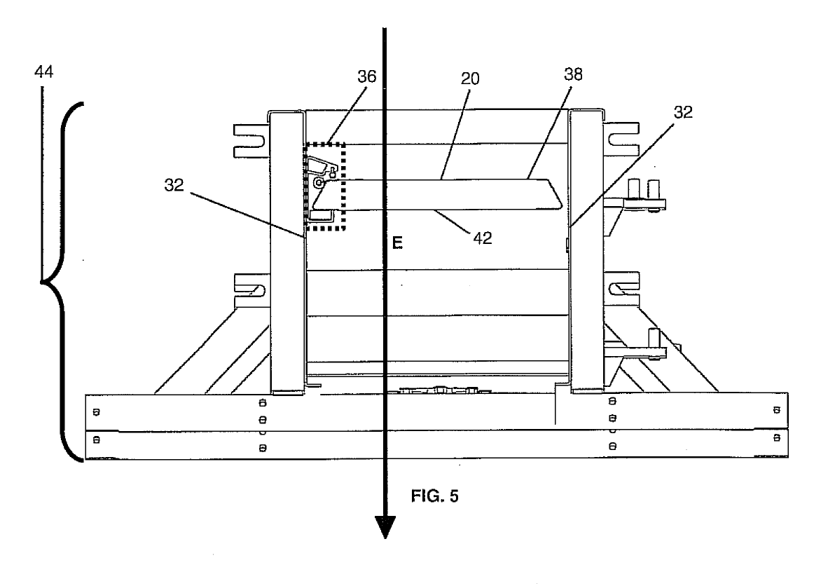

Referring to FIG. 1, a screen rail 40 that may partially enclose an inflatable seal 18 is shown. The screen rail 40 may be referred to as a clip. In an embodiment, the screen rail 40 may be used with a vibratory separator 44 as shown in FIG. 5, for example. The vibratory separator 44 may receive fluid, such as a slurry, having various components, such as mud, rocks, sand, drill cuttings, oil, grease and/or the like. Specifically, the vibratory separator 44 may have a ball box 20 enclosing vibratory elements, such as steel balls, for example. The ball box 20 may be inserted into the screen rail 40 and/or may otherwise be positioned at opposing ends of the vibratory separator 44 to assist in vibrating a screen assembly 26, as shown in FIG. 3. The screen assembly 26 may be stretched between opposing ends of the vibratory separator 44 and that may be placed on and/or above the ball box 20. Solid materials may be substantially separated from liquid in the slurry by the screen assembly 26, thus allowing for mostly liquid to pass through the vibratory separator generally in a direction D as shown in FIG. 5. The liquid may be recycled and/or re-used with drilling fluid to lubricate drill bits associated with drilling in oilfield operations, for example.

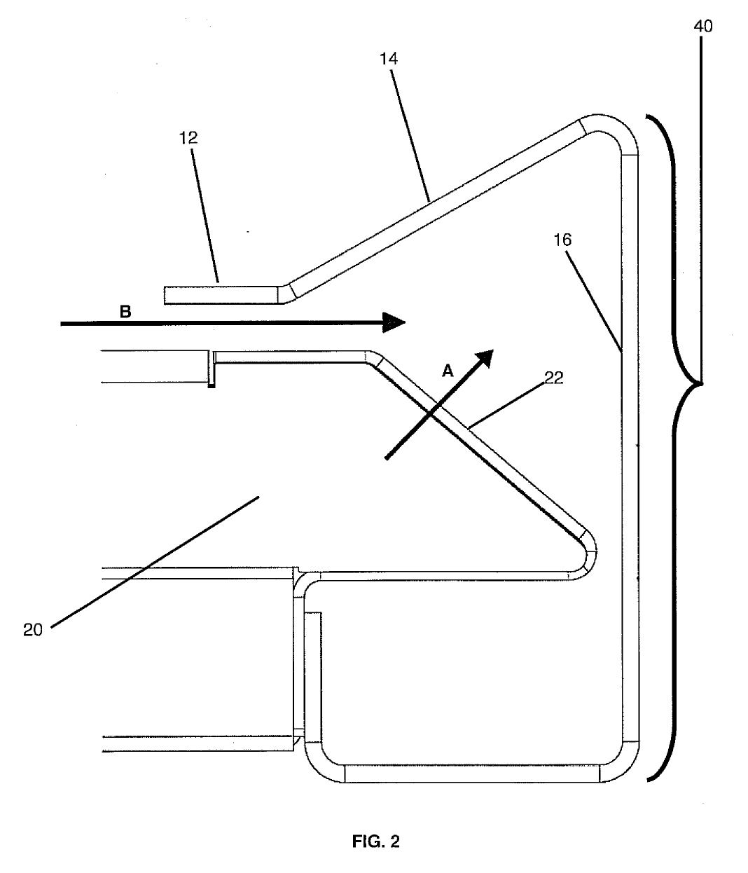

In an embodiment, the ball box 20 may be positioned generally adjacent to the screen rail 40. A cover 10 may be placed on and/or near the ball box 20 to direct incoming slurry throughout the vibratory separator 44. In an embodiment, the cover 10 may be removed to allow incoming slurry to contact the ball box 20 and/or other components of the vibratory separator 44. Further, an inflatable seal 18 may be positioned between the ball box 20 and an interior-facing wall 16 of the screen rail 40 to inflate and/or to expand generally outwards in direction. A as shown in FIG. 1. The screen assembly 26 may be threaded through the screen rail 14 in a direction B as shown in FIG. 2 to, for example, sit on the inflatable seal 18. Accordingly, the inflatable seal 18, upon inflation, may expand in the direction A, as shown in FIGS. 1 and 2. The inflatable seal 18, expanded in the direction A, may compress the screen assembly 26 against the interior-facing wall 16 of the screen rail 40 to hold the screen assembly 26.

In an embodiment, the inflatable seal 18 may be placed beneath the ball box 20. The inflatable seal 18 may receive air and/or other inflation fluid to expand in size. In an embodiment, the inflation of the inflatable seal 18 may be referred to as actuation. Accordingly, the inflatable seal 18 may be actuated beneath the ball box 20 to compress against and/or to force the screen assembly 26 laterally toward the interior-facing wall 16 of the screen rail 40. In an embodiment, the movement of the screen assembly 26 toward the interior-facing wall 16 may be referred to as linear displacement, which may tension the screen assembly 26 to hold and/or otherwise assist in the retention of the screen assembly in the vibratory separator 44.

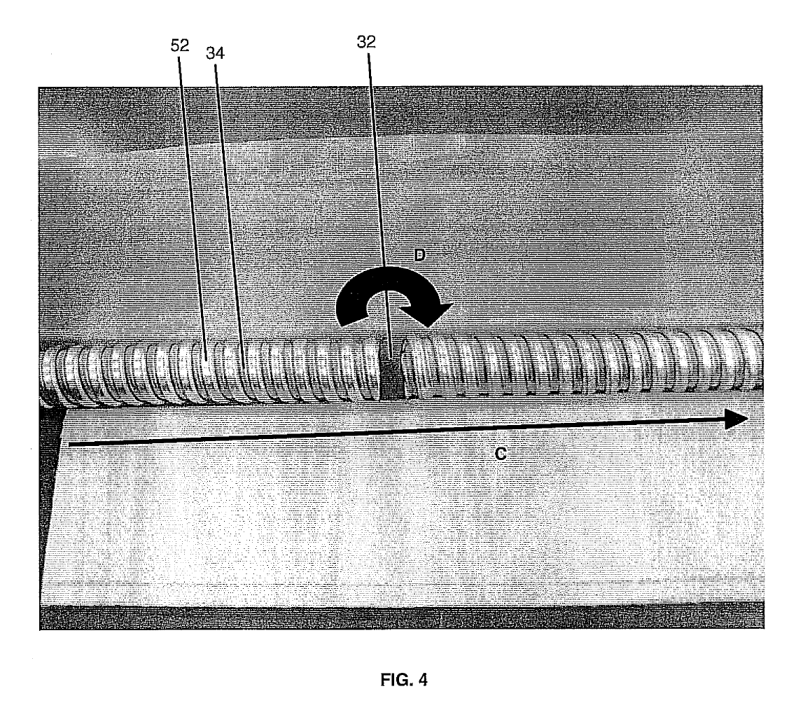

In an embodiment, the screen assembly 26 may be removed from the vibratory separator 44 and may be rolled along the lengthwise direction to produce a compressed screen 34, as shown in FIG. 4, for example. The compressed screen 34 may occupy less space relative to the screen assembly 26 when unfolded to insert in and/or install with the vibratory separator 44. Further, the compressed screen 34 which may be smaller than the screen assembly 26 when unfolded, may be conveniently stored and/or transported.

Referring to FIG. 2, a side view of the screen rail 40 partially enclosing the ball box 20 is shown. In an embodiment, the screen rail 40 may have a leading surface 14 that may extend toward a flat surface 12. The screen assembly 26 may be threaded through and/or inserted generally in the direction B, as shown in FIG. 2, to be substantially parallel to the flat surface 12. In an embodiment, the screen assembly 26 may be placed on and/or beneath the ball box 20. Vibration of the ball box 20 may result in vibration and/or movement of the screen assembly 26, which may filter solid materials from liquid in a slurry passing through the screen assembly 26.

The ball box 20 may have an edge 22 that may be inclined and/or may be generally angled toward the interior-facing wall 16 as shown in FIGS. 1 and 2, for example. The ball box 20 may rest on a bottom 24. A flexible clamping element 30, as shown in FIG. 3, may attach to the screen assembly 26 at a joining surface 28. In an embodiment, actuation of the inflatable seal may compress the flexible clamping element 30 against the interior-facing wall 16 to hold the screen assembly 26 in place on and/or beneath the ball box 20. In an embodiment, the flexible clamping element 30 may be generally shaped as a loop as shown in FIG. 3, for example. Vibration of the ball box 20 may vibrate the screen assembly 26 to assist in the filtration and/or collection of solids from slurry passing through the screen assembly 26.

Referring to FIG. 3, a side view of the screen assembly 26 that may be attached to the flexible clamping element 30 by the joining surface 28 is shown. In an embodiment, the screen assembly 26 may connect with the joining surface 28, which may extend from and/or cover the screen assembly 26 on a top side 46 of the screen assembly 26 and/or a bottom side 48 of the screen assembly 26. In an embodiment, the joining surface 28 may extend from the top side 46 to wrap around and/or to form a loop 50 that may generally enclose the screen assembly 26 and return to attach the bottom side 48 as shown in FIG. 3. In an embodiment, the loop 50 may engage with the vibratory separator 44 to assist in the installation and/or operation of the screen assembly 26.

Referring to FIG. 4, the compressed screen 34 may extend lengthwise in a direction C and may rotate generally around a break 32 in a direction D. In an embodiment, the break 32 may be referred to as a joint and/or as a crease. Rotation of the compressed screen 34 around the break 32 in the direction D may allow for the screen assembly 26 to generally reduce in size.

In an embodiment, the screen assembly 26 may be made from woven mesh that may flex and/or bend to allow for the rolling and/or coiling of the screen assembly along the direction C as shown in FIG. 4, for example. Further, the break 32 may extend width-wise across the screen assembly 26 and may be formed from and/or may be encapsulated by canvas and/or the like. In addition, the break 32 may be made from multiple materials selected in accordance with rigidity and/or thermal preferences. Such materials may include steel conduit, open and/or closed cell foam, multi-conductor cable and/or steel braided cable, for example. The screen assembly 26, coiled along direction C, may be inserted into a shipping container for storage and/or shipment.

Further, the break 32 may allow the screen assembly 26 to fold in the direction D prior to rolling to form the compressed screen 34. Specifically, the break 32 may have and/or be made from multiple types of compressive materials and/or knuckle-type assemblies. In an embodiment, the screen assembly 26 may have a ridge 52 extending width-wise across the screen assembly 26. Accordingly, the ridge 52 may extend away from the screen assembly 26 when rolled to form the compressed screen 34.

Also, the compressed screen 34 may attach to the inflatable seal 18 within the screen rail 40 as shown in, for example, FIG. 1, and be unrolled and/or decompressed. Accordingly, the inflatable seal 18 may be made from a relatively pliable material such as, but not limited to, rubber, composite and/or any combination of the same to accommodate the unfolding, unrolling and/or decompression of the compressed screen 34 attached to the inflatable seal 18 to insert into the screen rail 40.

Referring to FIG. 5, the vibratory separator 44 configured to receive the screen assembly 26 is shown. The ball box 20 may be located in a basket 32 of the vibratory separator 44. The ball box 20 may have a top surface 38 and a bottom surface 42 that may be positioned opposite to and substantially parallel to the top surface 38. Further, the ball box 20 may have angled ends 22. The ball box 20 may be supported and/or held within the basket 32. In an embodiment, the screen rail 40, the ball box 20 and the inflatable seal 18 may be collectively referred to as a screen tensioning system 36. Slurry may generally flow through the vibratory separator 44 in a direction R as shown in FIG. 5.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

1. An apparatus comprising:
a screen rail extending across a vibratory separator;
a ball box inserted in the screen rail wherein the ball box encloses vibratory elements;
a screen assembly on the ball box wherein the screen assembly is parallel to the screen rail and extends across the vibratory separator; and
an inflatable seal inserted into the screen rail wherein the inflatable seal receives fluid to inflate and compress the screen assembly against the screen rail.

2. The apparatus of claim 1 further comprising:
a clamping element attached to the screen assembly wherein the inflatable seal compresses the clamping element against the screen rail.

3. The apparatus of claim 1 wherein the inflatable seal is positioned between the ball box and the screen assembly.

4. The apparatus of claim 1 wherein vibration of the screen assembly filters a slurry passing through the screen assembly.

5. The apparatus of claim 1 wherein the screen assembly contacts the inflatable seal.

6. The apparatus of claim 1 further comprising:
a wall of the screen rail that holds the screen assembly.

7. The apparatus of claim 1 wherein the screen assembly is rolled to form a coil.

8. The apparatus of claim 1 further comprising:
a joint in the screen assembly wherein rotation of the screen assembly around the joint reduces the size of the screen assembly.

9. The apparatus of claim 1 further comprising:
a flexible clamping element is shaped as a loop wherein the flexible clamping element attaches to the screen assembly.

10. A system comprising:
a screen with a top side and a bottom side positioned opposite and parallel to the top side;
a clip configured to receive the screen;
a joining surface extending from the screen to form a loop; and
a seal inserted beneath the bottom side of the screen wherein the seal inflates to compress the loop to hold the screen against the clip.

11. The system of claim 10 wherein the screen rolls lengthwise to form a coil.

12. The system of claim 10 further comprising:
a hinge in the screen wherein rotation of the screen around the hinge reduces the size of the screen.

13. The system of claim 10 wherein the screen is a woven mesh.

14. The system of claim 10 further comprising:
a hinge that extends width-wise across the screen.

15. The system of claim 10 further comprising:
a hinge formed from canvas that extends across the screen.

16. The system of claim 10 further comprising:
a hinge in the screen wherein the hinge is made from materials selected in accordance with their physical properties.

17. The system of claim 10 wherein the screen is inserted into a shipping container for shipment.

18. A method comprising:
stretching a screen across side rails positioned opposite to each other;
inserting a seal into the side rails beneath the screen;
inflating the seal to expand the seal toward the side rails;
compressing the seal against the screen to hold the screen against the side rails.

19. The method of claim 18 further comprising:
retaining the screen against the side rails.

20. The method of claim 18 further comprising:
rolling the screen along a length of the screen.
